(19) United States
(12) Patent Application Publication
(10) Pub. No.: US 2005/0226193 A1
(43) Pub. Date: Oct. 13, 2005

(54) Monitoring quality of service in a wireless communications network

(75) Inventors: Marko Karhiniemi, Espoo (FI); Markku A. Oksanen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/927,477

(22) Filed: Aug. 27, 2004

(30) Foreign Application Priority Data
Mar. 31, 2004 (GB) 0407347.4

(51) Int. Cl. H04Q 7/24

(52) U.S. Cl. 370/338

(57) ABSTRACT

A method indicates quality of service status of a wireless communications network to a user. The method includes monitoring at least one quality of service parameter associated with the network. The method also includes delivering a value of the at least one quality of service parameter to a user terminal in the network and displaying an indicator of the quality of service status at the user terminal based on the value of the at least one quality of service parameter.

### FIELD

The present invention relates to monitoring quality of service in a wireless communications network.

### DISCUSSION OF RELATED ART

The quality of service (QoS) delivered by a wireless communications network is usually related to technical parameters in the network such as latency, bandwidth, packet loss, jitter, etc. The actual quality of a service or an application perceived by a user varies in dependence on these parameters, and also in dependence on the usage of the network, because the number of users of a network affects how network resources are shared.

Moreover, different types of applications delivered by a network have differing quality of service requirements. For example, certain applications need low packet loss or low latency to work, but are not bandwidth sensitive. Conversely, some applications require high bandwidth but are not sensitive to jitter or latency due to buffering.

For circuit-switched services in a network, such as voice calls, the quality of service is effected by congestion in the network due to traffic, and signal strength which is generally infrastructure dependent.

When delivering packet-based services or applications across a network, a packet data protocol (PDP) context is established between a mobile station, and serving GPRS support node (SGSN) and a mobile switching centre. Part of the context which is established is a set of QoS parameters determining the quality of service to be delivered for the particular transmission. A particular QoS is requested for establishment of a PDP context, and the SGSN node negotiates a quality of service within the network and establishes the PDP context based on the negotiated QoS. A user will often not know when he sets up a service what the negotiated QoS is. There are a number of classes of QoS policy parameters which form part of the QoS status set within a PDP context, which are discussed in more detail later. One of these classes is traffic precedence, which governs the priority with which packets falling within this class are treated. However, as it is clear that traffic has a significant effect on QoS offered by a particular network, it is desirable to prioritise traffic in other ways.

### SUMMARY

According to one aspect of the present invention there is provided a method of indicating quality of service status of a wireless communications network to a user comprising: monitoring at least one quality of service parameter associated with the network; delivering a value of the at least one quality of service parameter to a user terminal in the network; and displaying an indicator of the quality of service status at the user terminal based on the value of the at least one quality of service parameter.

Another aspect of the invention provides a mobile terminal for use in a wireless communications network comprising: a receiver adapted to receive over a wireless interface a value of at least one quality of service parameter associated with the network; a map which correlates values of said at least one quality of service parameter with a displayable indicator representing the value; and a display arranged to display the indicator corresponding to the received value.

A further aspect of the invention provides a network entity used in a wireless communication network and comprising means for monitoring at least one quality of service parameter in the network and for providing a value indicative of the quality of service parameter to a user terminal in the network.

A further aspect of the invention provides a computer program product comprising program code means executable by a processor at a mobile terminal in a wireless communications network to cause the mobile terminal to implement the following steps: comparing a received value of a quality of service parameter indicative of quality of service status in the network with predetermined values to select a displayable indicator associated with the received value and displaying the indicator to a user of the mobile terminal.

In the preferred embodiment, the displayed indicator is colour. That is, a red colour denotes low values for the monitored quality of service parameter, whereas a green colour denotes high values for the quality of service parameter, with orange and yellow indicating intermediate levels. It will be appreciated however, that other displayable indicators can be used such as numbers, words or icons.

It is of course possible to monitor several quality of service parameters to indicate an overall QoS status which is mapped to a particular colour.

By making users aware of the quality of service deliverable by the network at any particular instance, the user himself can decide to assist in prioritising traffic, by not attempting to start a service which is indicated as having a low level of quality of service, in particular where this is as a result of a number of existing users using the same service. This also has an impact in that users already using the service can get a very good quality of service because other users are not continually joining in to use the same application.

As an alternative to or additionally to the users prioritising their own traffic, a network operator could deny certain applications (e.g. high bandwidth video streaming) during poor service congestion time (e.g. red QoS colour).

The required quality of service for an application can be set automatically at the user terminal when the application is installed, or can be set manually by a user if he wishes to apply different quality of service requirements when using the application.

Other advantages are that the system provides a simple end user friendly human readable way of presenting QoS information.

It allows the possibility to give information of a failure point so that the user does not think that his own user terminal/device is broken.

It allows the possibility to predict the quality of service at certain areas so that a user can decide to avoid poor quality of service time/places.

The invention is also useful in a situation where mobile terminals have multiple radio interfaces, with each of the radio interfaces (e.g. EDGE, WLAN, BLUETOOTH) having radically different characteristics, for example related to bandwidth and latency. It cannot be assumed that end users are familiar with the network technologies and can determine which applications will operate with certain interfaces. In this context also, an indicator of the quality of services supplied to a user, for example by colour, is very useful.

The display can be arranged to display the indicator on a real time basis corresponding to the receipt of said values of said at least one quality of service parameter. Alternatively, the display can comprise damping means configured to display said values in a damped manner, for example when they are changing too rapidly. As an example, an average over the previous five minutes could be displayed for example.

Alternatively or additionally, the display can be configured to display the indicator corresponding to the received value only when the value changes beyond a predetermined threshold. This again is an acceptable alternative to continuously attempting to display the indicator values on a real time basis.

When the mobile terminal is configured to generate a request for quality of service status when requesting delivery of a service over the network, it can comprise a store for holding the address of a network entity to which the request for quality of service status is to be dispatched. The network entity to which the request is addressed, can comprise means for receiving the request and providing said value indicative of the quality of service parameter to the mobile terminal responsive to the request. The request for quality of service status can be selected from the group comprising short message service (SMS), (MMS), SIP signalling and instant internet messaging services.

Alternatively, the network entity can have means for providing said value indicative of the quality of service parameter on a push basis to the mobile terminal.

In addition to prior service delivery, QoS information can be provided all the time so that, for example, if an application stops working an end user can notice that the network conditions have changed radically. Additionally, a user could be notified with prompt windows when the network quality status changes significantly. Additionally, an operator could gather network quality status information and update the network/fixer network in a certain area if the resources are not adequate.

### BRIEF DESCRIPTION OF THE DRAWINGS

For a better understanding of the present invention and to show how the same may be carried into effect, reference will now be made by way of example to the accompanying drawings, in which:

FIG. 1 is a schematic diagram illustrating the architecture of a wireless mobile communications network;

FIG. 2 is a schematic diagram illustrating the architecture of a wireless communications network including a QoS monitor in accordance with an embodiment of the invention;

FIG. 3 is a schematic circuit diagram of the circuitry at a user terminal for displaying QoS status;

FIG. 4 is an example of a mobile telephone with a QoS display indicator; and

FIG. 5 is an example of a mobile telephone with a display showing more detailed QoS indications.

### DETAILED DESCRIPTION

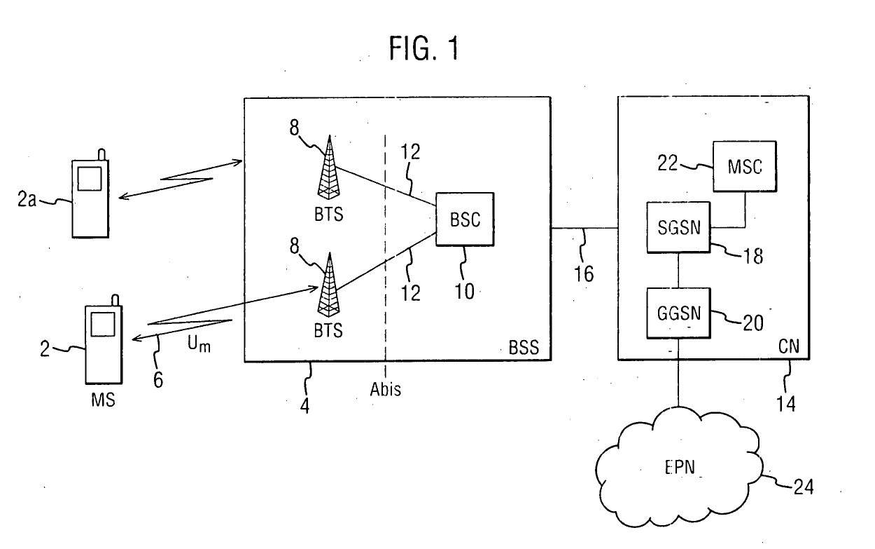

FIG. 1 illustrates a typical architecture of a wireless mobile communications cellular network. A user terminal 2 in the form of a mobile station MS is connected to a base station sub-system BSS 4 over a wireless interface 6 denoted Um. The base station sub-system 4 comprises a plurality of base stations, BTS 8, only two of which are shown in FIG. 1. It will readily be appreciated that the base station sub-system has a plurality of base stations. Each group of base stations 8 are managed by a base station controller BSC 10 which communicates with the base stations over an interface 12 referred to as the Abis interface. Once again it will be appreciated that the base station sub-system can have more than one base station controller BSC depending on the implementation. Although not illustrated, it will be understood that the base station sub-system manages a communications network which is organised in cells, with a base station 8 serving one or more cell. The precise details of a cellular communications network are not shown here because they are well known in the art.

The base station sub-system BSS communicates with the core network CN 14 over an interface 16 which can be a Gb interface or an A interface depending on the implementation of the core network. The core network is shown to comprise a serving GPRS support node SGSN 18 connected to a gateway GPRS support node GGSN 20 and a mobile switching centre MSC 22. The gateway GPRS support node 20 is connected to an external packet network EPN 24.

The architecture illustrated in FIG. 1 supports different kinds of services. These fall broadly into circuit-switched services such as voice calls and packet-switched services, such as video. Circuit-switched services are those where a physical radio channel is established between the mobile station 2 and the base sub-station 4 under the control of the core network 14 and then data, e.g. voice data is transmitted along the channel to implement a call between two user terminals. As an example, a second user terminal is shown illustrated as 2a, but it will be appreciated that the second user terminal can be anywhere in the network. The quality of service of calls is determined by infrastructure parameters in the network, such as buffers, and by traffic in the network which affects signal loss, jitter/latency and bandwidth. Quality of service for a call is mainly governed by signal strength, which is managed by handover procedures in the network at the physical interface Um as the mobile station moves around.

For packet-based services such as user applications like entertainment services, gaming or video streaming, the quality of service which is delivered is still of course dependent on the above parameters in the network. However, it is managed in a different way. That is, QoS (quality of service) policy parameters are divided into five different classes, each class having a number of different levels which determines how the quality of service for any particular transmission is handled in that class. The classes are:
traffic precedence class
delay class
reliability class
peak throughput class
mean throughput class.

In the delivery of packet-based services, a PDP (packet data protocol) context is established between the user terminal 2 and the mobile switching centre 22 via the base sub-service station BSS and the serving GPRS support node 18. When a PDP context is to be established, the establishing entity (which can be the user terminal or in some cases the network) requests a certain quality of service (requested QoS) depending on the nature of the service and subscriber limitations, and the serving GPRS support node 18 receives the request and then negotiates a quality of service element based on its current capabilities, its current load and the subscribed quality of service profile for the user. The serving GPRS support node 18 returns a negotiated QoS for establishment of the PDP context to deliver the particular service. The negotiated QoS will be sufficient to deliver the service, but it may not be as good as the requested QoS.

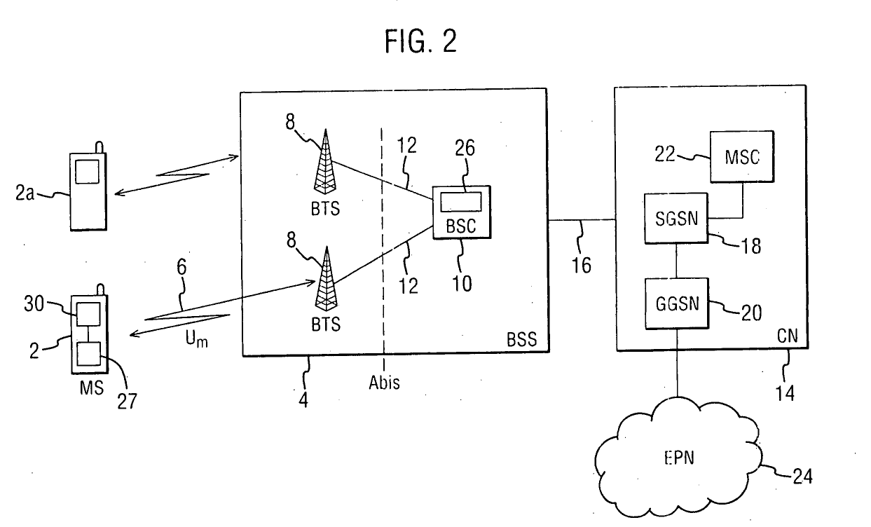

FIG. 2 illustrates an improved version of the architecture of FIG. 1 wherein the base station controller 10 includes a quality of service monitor 26. The QoS monitor 26 monitors the actual delivered quality of service at any particular time over the Um interface 6. It has been established that in a wireless communications network, the most significant bottleneck affecting quality of service is the radio interface itself. Of course, it is also possible to monitor the quality of service delivered over any other interface in the network, and the present invention should not be considered to be limited to monitoring the quality of service only over the radio interface. The QoS monitor can be implemented at the BTS itself, or in some other place in the network. The QoS monitor 26 analyses user throughput, response time and other information to monitor actual QoS parameters to calculate the user perceived quality of service, and this can be done on a real time basis. For example, the QoS monitor 26 can monitor, for circuit-switched services, traffic in the network to determine a congestion parameter indicative of the likely quality of service if a new user attempts to establish a new voice channel. For packet-switched services, the QoS monitor 26 can monitor the QoS parameters in the quality of service classes which are carried by the PDP context. In existing networks, traffic information is already stored at the base station controller 10, and the QoS parameters of PDP contexts are also stored there. However, it is also anticipated that the base station controller could be enhanced to monitor new and different quality of service parameters for delivery from the network side. Based on the monitored QoS parameters, the BSC 10 can deliver QoS status indicators representative of a number of different service aspects.

For example, a QoS status indicator representative of traffic, which would provide an indication of likely congestion for establishment of a call and which is therefore indicative of general network quality can be delivered.

Alternatively, QoS indicators which pertain to particular quality of service parameters established in PDP contexts can be delivered on a per application basis. That is, any particular packet based application which is to be delivered over the network will have its own QoS requirements defined in terms of the QoS parameters in the five different classes described above. The QoS monitor 26 can deliver an indicator representative of the level of QoS for each parameter which is deliverable by the network at any given time, which will depend, amongst other things, on current usage of the network as well as on the basic infrastructure of the network. The QoS status can be delivered periodically or in real time or at the request of a user.

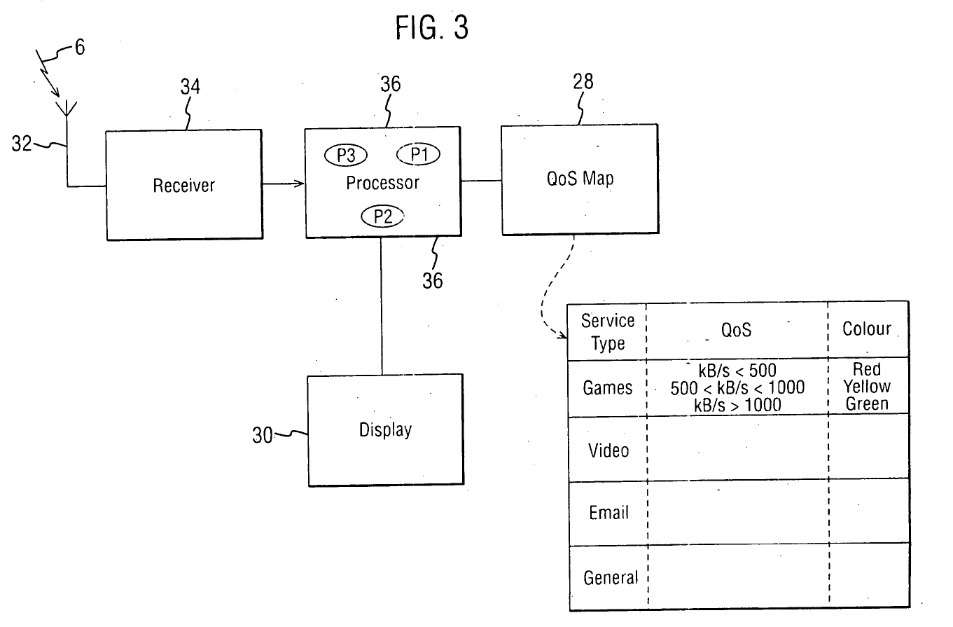

At the user side, a user terminal 2 includes circuitry for receiving the QoS status indicators and displaying QoS status to a user graphically. In the described embodiment, the QoS status (in terms of these parameters) can be delivered using a specific protocol, and can be delivered continuously or by polling either initiated from the network side or from the side of the user terminal. The user terminal 2 includes a QoS map 28 (FIG. 3) which maps the received QoS status indicators to reference colours which can be related to general network conditions, to a certain type of application or to a user defined QoS/application parameter. In accordance with a described embodiment of the invention, the quality of service parameter or parameters determined by the QoS monitor 26 are supplied to the user terminal 2 over the radio interface 6. The received QoS parameter or parameters are mapped to reference colours in the QoS circuitry 27 and these colours are displayed on a display 30 of the user terminal 2.

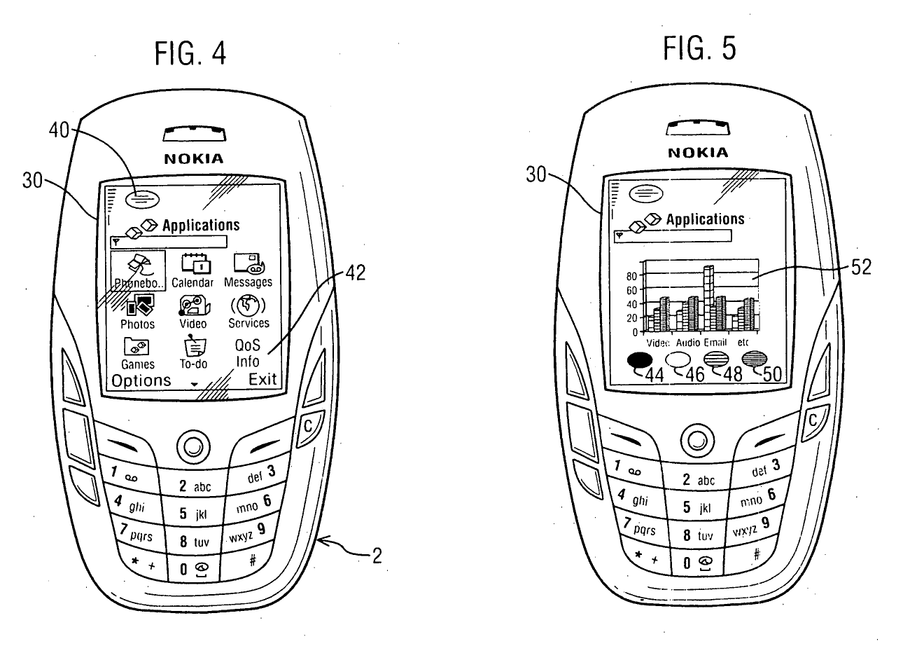

FIG. 3 is a schematic diagram of components at the user terminal 2. An antenna 32 receives radio signals across the radio interface 6, these signals including QoS status indicator values. A receiver 34 receives the signals and converts them to digital data which is supplied to a processor 36. The processor executes a QoS status program P1 which reads the colour reference values from QoS map 28 which are mapped to the incoming QoS indicator values and supplies them to the display 30 via a display driver program P2. As illustrated by way of example in FIGS. 4 and 5, the display can then show differing colour buttons depending on the QoS status for executing different types of applications.

FIG. 4 illustrates a mobile telephone 2 having a display 30 which includes a number of icons for selecting different menu possibilities. In addition, the display shows a colour button 40 which is indicative of the general network quality of service status. This colour button 40 will vary in colour depending on the quality of service status of the network as delivered by the QoS monitor 26.

The menu icons include an icon 42 for selecting quality of service information. When the user actuates this icon, the display changes to that shown in FIG. 5. The display 30 in FIG. 5 shows two possibilities for graphically indicating quality of service status to a user, which can be used singly or together. The first way is to provide a series of colour buttons 44, 46, 48, 50 which are associated with particular applications such as video, audio, email and other services (for example games).

An alternative way of indicating the quality of service status to a user is by way of a bar chart, with different coloured bars associated with each of the applications as denoted by reference numeral 52.

As an example of how the colours could be used to assist traffic in a network, when a user wishes to use a gaming service, he can select the gaming service and his display will indicate a yellow-orange colour for button 50 for gaming, which means that the network resources for that service are not optimal, however they might still be working because the colour indication is not red. However, the video streaming service shows a yellow-green colour for its button 44 on the display which means that that service should work adequately to excellently. In this particular case, the user can select the video streaming service and make a decision to play the game later when the network resources for the gaming service are more optimal.

FIG. 3 illustrates an example of a QoS map 28, which can be set up in the form of a database or any other suitable memory structure. The map shows service type, such as games, video or general, where general denotes the general network conditions for circuit switched applications, QoS limits and colours. For each service type or applications which provide QoS information at the installation phase, the QoS limit is established which provides a quality of service needed for delivery of that service type. For example, real-time games cannot generally be played with a latency in excess of 500 ms, while latencies below 200 ms are acceptable. Therefore, the latencies for general real-time gaming in a mobile environment can be mapped to colour indication as follows:
less than 300 green
300 to 600 green/yellow
equal to 600 yellow
600 to 900 yellow/red
greater than 900 red.

That is, for example, when the colour indication is yellow the game can be played but possibly with not particularly good results. When the colour indication is green, the game can be played without problems because the required quality of service is available.

The quality of service limit which can be set in association with particular colours can either be preset based on a certain application type when an application is installed on a user terminal, or can be set by a user. In this way, a user can personalise his quality of service requirements.

Applications can provide quality of service requirement information, which can be further mapped to colours.

The QoS indicator values can be received at the mobile station 2 during the set-up procedure for delivery of the service. That is, for circuit switched based services, when a new channel is to be established, part of the channel establishment procedure includes a request for the QoS indicator values associated with that channel or with the network in general. These values are supplied to the processor 36 which then displays the appropriate colour button on the display in accordance with whatever values are set in the QoS map 28. Similarly, for packet based services, when a request is made to the network for delivery of a packet based service, the service which has been selected the network indicates the QoS which has been negotiated for that service in establishment of the PDP context. That negotiated QoS is supplied to the mobile station and the colour value associated with it from the QoS map 28 is displayed to a user. On this basis, the user can determine whether or not he wishes to proceed with the purchase of that service at that particular time, or whether he would rather wait until a better quality of service indication is given.

According to another example, a third party could compare the services offered by differing operators by recording subscriptions with differing operators and comparing the delivered QoS parameters for the same application with the different operators. The measurement results could then be used in an advertisement for example to indicate that a certain operator has better network quality of service than another operator in a certain area, by referring to, for example, the fact that the first operator has green-yellow buttons and the second operator has yellow-red buttons for that service.

With a number of user terminals in a particular area, it is possible to gather QoS status information to provide so-called QoS area maps. From the colour indications displayed in the user terminals, it is possible to gather statistical data related to different areas. For example, one part of town could have 80% of the time a yellow colour quality of service and 20% of the time a red colour quality of service. Another part of the town could have a 50% green colour quality of service and a 50% yellow colour quality of service. By gathering statistical data relating to different areas, and also with knowledge of the average number of users in those areas, it is possible to consider QoS forecasting. That is, if the number of users in a particular area is likely to increase dramatically, for example by a festival or concert of some kind, it is clear that the quality of service in the area will fall due to the expected increase in the number of people using the network. It is possible to forecast the likely effect on the decrease in the quality of service using the previously gathered statistical data, so that for example one could say that normally the area would have green-yellow buttons, but due to the upcoming festival the perceived quality of service is likely to decrease to yellow-red buttons.

It is also possible to use the delivery of QoS parameters to individual users to allow a user to select a better service quality and to pay for it even where there is congestion in the network. The amount of extra payment and quality increase can be indicated to a user using the colours and related to the application the user wishes to use. The quality increase depends on the other users (and if they are using a basic or premium service) in addition to other matters which are more defined by the network such as overall traffics, characteristics of certain network types, etc. Thus, with the colours the instant quality increase related to the extra payment can be indicated.

As it is expected that the quality of service data will vary all the time, and in particular from second to second it might change due to subscriber movements and load changes in the network, it is possible to provide a damping feature in the delivery of changes to the colours from the processor 36 to the display 30. This means that the display changes only for example, every five minutes or so and is based on average values over that period rather than instantaneous values. To this end, the processor 36 can include an averaging algorithm P3.

QoS status parameters can be delivered across the wireless interface 6 by using a simple protocol between the user terminal and the base station sub-system, which measures critical parameters and network behaviour. It has been established that, mostly, the link between the user terminal and the base station BTS is the bottleneck from a quality of service point of view, so that good QoS indications can be achieved by a QoS monitor at the BTS itself or at the BSC. Of course a QoS monitor could be located anywhere in the network.

The above-described system for supplying quality of service status information graphically to a user solves a very real problem. In particular, it aids in prioritising traffic by user behaviour itself, because a user will not seek to use a service where the quality of service is indicated to him as too low. Prior to the present invention, it has been difficult to find a suitable solution which combines usability, economics and technology. One reason is that users are not aware of the underlying technology or even aware of the technology that they are using. From the user's perspective, he only want an answer to the basic question is something working okay/is it not working/is it working excellently? It is useful therefore for a user to know when problems arise from lack of resources in the network rather than from his own user terminal. Status information distribution of congestion helps the situation considerably because users do not get frustrated in trying to start the same non-functional service. Moreover, users who are already using the service, can continue to get fine service because new users do not continue trying and therefore decrease the quality of the service.

1. A method of indicating quality of service status of a wireless communications network to a user, the method comprising:
monitoring at least one quality of service parameter associated with a network;
delivering a value of the at least one quality of service parameter to a user terminal in the network; and
displaying an indicator of a quality of service status at the user terminal based on the value of the at least one quality of service parameter.

2. A method according to claim 1, wherein the displaying step comprises displaying the indicator, wherein the indicator comprises a color.

3. A method according to claim 1, further comprising selecting one of a plurality of indicators, wherein each indicator is associated with a range of values for the quality of service parameters.

4. A method according to claim 1, further comprising indicating a quality of service status for circuit-switched services derived from the quality of service parameter, wherein the quality of service parameter represents traffic in the network.

5. A method according to claim 1, further comprising selecting the at least one quality of service parameter from a group of quality of service parameters settable for delivery of packet-based services over the network.

6. A method according to claim 1, wherein the step of delivering the value comprises delivering the value on request from a user terminal prior to delivery of a service desired by a user.

7. A method according to claim 1, further comprising the step of delivering a service selected from a plurality of services, each service having an associated required quality of service status to be provided by the network for delivery of the service over the network, wherein the step of displaying the indicator comprises displaying indicators for each service.

8. A method according to claim 1, further comprising the step of setting the quality of service status at the user terminal.

9. A mobile terminal for use in a wireless communications network, the mobile terminal comprising:
a receiver configured to receive over a wireless interface a value of at least one quality of service parameter associated with a network;
a map which correlates values of said at least one quality of service parameter with a displayable indicator representing the value; and
a display configured to display the indicator corresponding to the received value.

10. A mobile terminal according to claim 9, wherein the display is configured to display the indicator on a real-time basis corresponding to receipt of said values of said at least one quality of service parameter.

11. A mobile terminal according to claim 9, wherein the display comprises damping means configured to display said values in a damped manner.

12. A mobile terminal according to claim 9, wherein the display is configured to display the indicator corresponding to the value when said value changes beyond a predetermined threshold.

13. A mobile terminal according to claim 9, wherein the display comprises a multicolor display and said indicator comprises a color.

14. A mobile terminal according to claim 9, wherein the map holds a plurality of indicators, each indicator associated with a range of the values for the at least one quality of service parameter.

15. A mobile terminal according to claim 9, further comprising circuitry for generating a request for quality of service status when requesting delivery of a service over the network.

16. A mobile terminal according to claim 15, further comprising a store for holding an address of a network entity to which the request for quality of service status is to be dispatched.

17. A mobile terminal according to claim 9, wherein the map holds indicators for a plurality of services deliverable over the network, each service having an associated required quality of service status for delivery of the service over the network.

18. A mobile terminal according to claim 17, further comprising means for setting the required quality of service status for each service, in a manner such that the indicator indicative of the value is displayable to a user.

19. A mobile terminal according to claim 18, wherein the means for setting the required quality of service status for each service comprises means for extracting said required quality of service status from an application installable at the mobile terminal.

20. A network entity used in a wireless communication network, the network entity comprising:
means for monitoring at least one quality of service parameter in a network; and
means for providing a value indicative of the at least one quality of service parameter to a user terminal in the network.

21. A network entity according to claim 20, further comprising means for receiving a request for quality of service status from the user terminal, and providing said value indicative of the at least one quality of service parameter to said user terminal responsive to said request.

22. A network entity according to claim 21, wherein the means for receiving the request selects the request for quality of service status from the group comprising SMS, MMS, SIP signalling, and instant internet messaging.

23. A network entity according to claim 21, further comprising means for providing said value indicative of the quality of service parameter on a push basis to a user terminal in the network.

24. A computer program embodied on a computer readable medium comprising program code means executable by a processor at a mobile terminal in a wireless communications network to cause the mobile terminal to implement the following steps:
comparing a received value of a quality of service parameter indicative of quality of service status in the network with predetermined values to select a displayable indicator associated with the received value; and
displaying the indicator to a user of the mobile terminal.
